(19) United States
(12) Patent Application Publication
(10) Pub. No.: US 2025/0179378 A1
(43) Pub. Date: Jun. 5, 2025

(54) CHEMICAL RECYCLING FACILITY WITH REDUCED WATER CONSUMPTION

(71) Applicant: Eastman Chemical Company, Kingsport, TN (US)

(72) Inventors: Michael Gary Polasek, Longview, TX (US); Xianchun Wu, Longview, TX (US); David Eugene Slivensky, Tatum, TX (US); Daryl Bitting, Longview, TX (US)

(73) Assignee: Eastman Chemical Company, Kingsport, TN (US)

(21) Appl. No.: 18/845,916

(22) PCT Filed: Mar. 15, 2023
(86) PCT No.: PCT/US2023/064396

§ 371 Date: Sep. 11, 2024

Related U.S. Application Data
(60) Provisional application No. 63/269,478, filed on Mar. 17, 2022.

(51) Int. Cl. C10G 55/04; B01D 51/10; B01D 53/14; C10B 53/07; C10G 9/36

(52) U.S. Cl. CPC C10G 55/04; B01D 51/10; B01D 53/1456; C10B 53/07; C10G 9/36; B01D 2251/304; B01D 2251/306; B01D 2251/604; B01D 2252/103; B01D 2256/24; B01D 2257/302; B01D 2257/404; B01D 2257/502; B01D 2257/504

(57) ABSTRACT

Processes and facilities for providing recycled content hydrocarbon products (r-products) from the pyrolysis of waste plastic and cracking of the resulting recycled content streams are provided. Processing schemes are described herein that reduce overall water consumption, which helps increase energy efficiency and minimize overall environmental impact of the facility, while producing valuable final products from chemically recycled waste plastic.

### BACKGROUND

Waste plastic pyrolysis plays a part in a variety of chemical recycling technologies. Typically, waste plastic pyrolysis facilities produce recycled content pyrolysis oil (r-pyoil) and recycled content pyrolysis gas (r-pygas) that can be further processed in, for example, steam cracking facilities to provide a variety of recycled content chemical products and intermediates, such as recycled content ethylene (r-ethylene), recycled content ethane (r-ethane), recycled content propylene (r-propylene), recycled content propane (r-propane) and others.

Chemical recycling facilities, including both waste plastic pyrolysis and hydrocarbon cracking facilities, utilize large amounts of water. Water withdrawn from surface source water (such as a lake, pond, or river) can be treated and then used within the facility as cooling water, boiler feed water, and other process water streams. Ideally, the water is recirculated and reused within the facility, but inevitably, a portion of the water is lost to the surrounding environment and/or is treated further and returned to the surface source.

Not only can such a processing scheme be energy intensive, but it also requires large volumes of water, which is a key natural resource utilized in almost all other industrial facilities, as well as for agricultural and residential purposes. In many places, the availability of surface water for such purposes may be declining and, therefore, minimizing water consumption may be desirable both the standpoint of energy efficiency within the facility, as well as for environmental conservation.

### SUMMARY

In one aspect, the present technology concerns a process for producing a recycled content hydrocarbon product (r-hydrocarbon product), the process comprising: (a) cracking a recycled content hydrocarbon feed (r-hydrocarbon feed) stream in a cracker furnace in a cracker facility to provide a cracked gas stream; (b) quenching at least a portion of the cracked gas stream in a quench zone of the cracker facility to provide a cooled cracked gas stream; (c) withdrawing a process water stream from the quench zone; and (d) contacting at least a portion of the cooled cracked gas stream with at least a portion of the process water stream in an acid gas removal zone of the cracker facility.

In one aspect, the present technology concerns a process for minimizing water consumption in a process for making a hydrocarbon product, the process comprising: (a) generating steam in a steam generator; (b) withdrawing a blowdown stream from the steam generator; (c) cooling at least a portion of the blowdown stream; and (d) contacting a hydrocarbon-containing gas stream with at least a portion of the blowdown stream in a caustic tower to provide a treated gas stream.

In one aspect, the present technology concerns a process for producing a recycled content hydrocarbon product (r-hydrocarbon product), the process comprising: (a) cracking a hydrocarbon-containing feed stream in a cracker furnace to form a cracked gas stream; (b) quenching at least a portion of the cracked gas stream in a quench zone to form a cooled cracked gas stream; (c) removing acid gas components from at least a portion of the cooled cracked gas stream in an acid gas treatment zone to provide a treated gas stream, wherein at least a portion of the acid gas removal is performed in a caustic tower; (d) compressing at least a portion of the treated gas stream in a compression zone to form a compressed gas stream; (e) separating at least a portion of the compressed gas stream in a separation zone to form at least one r-hydrocarbon product; (f) generating steam in a steam generator; (g) withdrawing a blowdown stream from the steam generator; and (h) introducing at least a portion of the blowdown stream into the caustic tower.

### BRIEF DESCRIPTION OF THE DRAWINGS

FIG. 1 is a block flow diagram depicting the main processing steps/facilities of a chemical recycling facility for recycling mixed plastic waste, including a plastics processing step/facility, a pyrolysis step/facility, and a cracking step/facility;

FIG. 2 is a block flow diagram depicting the main steps/facilities of a water system for use in a chemical recycling facility such as the facility shown in FIG. 1;

FIG. 3 is a block flow diagram depicting the main steps/facilities of a water system for use in a cracking facility, particularly illustrating the treatment and reuse of a blowdown stream from the steam generator;

FIG. 4 is a block flow diagram depicting the main steps/facilities of water system for use in a cracking facility, particularly illustrating the use of recycled process water for use in an acid gas removal step/zone;

FIG. 5 is a schematic diagram of a caustic tower suitable for use in an acid gas removal step/zone as shown in FIG. 4;

FIG. 6a is a block flow diagram of portions of a plastics processing facility and a pyrolysis facility, particularly illustrating heat integration of select processing units according to one or more embodiments of the present technology; and

FIG. 6b is a block flow diagram of portions a plastics processing facility and a pyrolysis facility, particularly illustrating heat integration of select processing units according to one embodiment or in combination with any other mentioned embodiments of the present technology.

### DETAILED DESCRIPTION

We have discovered methods and systems for chemically recycling waste plastic with reduced water consumption. By integrating various components of the cooling water, steam, and process water systems of plastics processing, pyrolysis, and/or cracking facilities, we have discovered chemical recycling process schemes that consume less water and are more energy efficient. This not only reduces operating costs, but also facilitates water preservation.

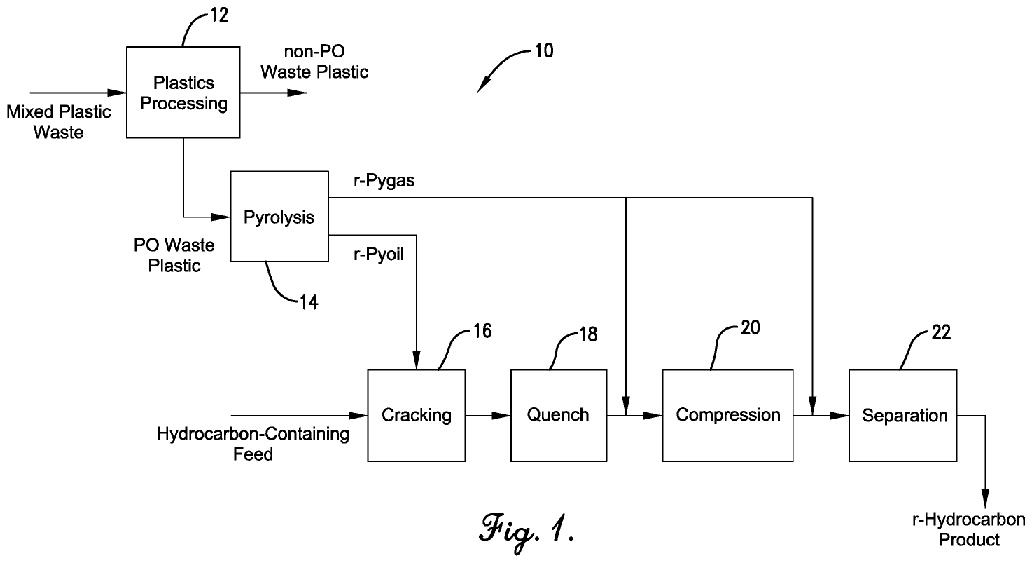

Turning initially to FIG. 1, a process and system for use in the chemical recycling of waste plastic to provide at least one recycled content hydrocarbon product (r-hydrocarbon product) is provided. The chemical recycling facility 10 shown in FIG. 1 includes a plastics processing facility 12, a pyrolysis facility 14, and a cracking facility. Chemical recycling facilities are not the same as mechanical recycling facilities. As used herein, the terms “mechanical recycling” and “physical recycling” refer to a recycling process that includes a step of melting waste plastic and forming the molten plastic into a new intermediate product (e.g., pellets or sheets) and/or a new end product (e.g., bottles). Generally, mechanical recycling does not substantially change the chemical structure of the plastic being recycled. The chemical recycling facilities described herein may be configured to receive and process waste streams from and/or that are not typically processable by a mechanical recycling facility.

In one embodiment or in combination with any other mentioned embodiments, at least two of the plastics processing facility 12, the pyrolysis facility 14, and the cracking facility may be co-located. As used herein, the term “co-located” refers to the characteristic of at least two objects being situated on a common physical site, and/or within 5, within 2, within 1, within 0.75, within 0.5, or within 0.25 miles of each other, measured as a straight-line distance between two designated points.

When two or more facilities are co-located, the facilities may be integrated in one or more ways. Examples of integration include, but are not limited to, heat integration, utility integration, waste-water integration, mass flow integration via conduits, office space, cafeterias, integration of plant management, IT department, maintenance department, and sharing of common equipment and parts, such as seals, gaskets, and the like.

One or more, or all, of the plastics processing facility 12, the pyrolysis facility 14, and the cracking facility can be commercial scale facilities. For example, in one embodiment or in combination with any other mentioned embodiments, the plastics processing facility/step and/or the pyrolysis facility/step can accept a stream of mixed waste plastic at an average annual feed rate of at least 500, at least 1000, at least 1500, at least 2000, at least 5000, at least 10,000, at least 50,000, at least 100,000, at least 150,000, or at least 200,000 pounds per hour, averaged over one year. In one embodiment or in combination with any other mentioned embodiments, the pyrolysis facility 14 and/or the cracking facility can produce one or more recycled content product streams (or receive one or more feed streams) at an average annual rate of at least 100, or at least 1000, at least 1500, at least 2000, at least 2500, at least 5000, at least 10,000, at least 50,000, at least 75,000, at least 100,000, at least 150,000, or at least 200,000 pounds per hour, averaged over one year. When more than one r-product stream is produced, these rates can apply to the combined rate of all r-products. Alternatively, or in addition, the feed stream or streams introduced into one or more of these facilities can have an average mass flow rate of at least 500, at least 1000, at least 2500, at least 5000, at least 10,000, at least 50,000, at least 75,000, at least 100,000, at least 150,000, or at least 200,000 pounds per hour, averaged over one year.

One or more (or two or more or all), of the plastics processing facility 12, the pyrolysis facility 14, and the cracking facility can be operated in a continuous manner. For example, each of the processes within each of the facilities and/or the process amongst the facilities may be operated continuously and may not include batch or semi-batch operation. In one embodiment or in combination with any other mentioned embodiments, at least a portion of one or more of the facilities may be operated in a batch or semi-batch manner, but the operation amongst the facilities may be continuous overall.

As shown in FIG. 1, mixed plastic waste can be introduced into the plastics processing facility 12, wherein it can be separated into a waste plastic stream comprising predominantly polyolefin (PO) and a waste plastic stream comprising predominantly non-PO plastics, such as polyethylene terephthalate (PET), polyvinyl chloride (PVC), and others. As used herein, the term “predominantly” means at least 50 weight percent. In one embodiment or in combination with any other mentioned embodiments, the predominantly PO waste plastic stream comprises at least 50, at least 60, at least 70, at least 80, at least 90, or at least 95 weight percent of PO, based on the total weight of the stream.

As used herein, the terms “mixed plastic waste” and “MPW” refer to a mixture of at least two types of waste plastic including, but not limited to the following plastic types: polyethylene terephthalate (PET), one or more polyolefins (PO), and polyvinylchloride (PVC). In one embodiment or in combination with any other mentioned embodiments, the MPW can include at least 20, at least 25, at least 30, at least 35, at least 40, at least 45, at least 50, at least 55, at least 60, at least 65, at least 70, at least 75, at least 80, at least 85, at least 90, or at least 95 weight percent PO, based on the total weight of the stream. Alternatively, or in addition, the MPW comprises not more than 99.9, not more than 99, not more than 97, not more than 92, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, or not more than 5 weight percent PO, based on the total weight of the stream.

In addition to PO, the MPW can include non-PO components, such as other, non-PO waste plastics (e.g., PET, PVC, and others), as well as non-plastic components such as glass, metals, dirt, sand, and cardboard. In one embodiment or in combination with any other mentioned embodiments, the non-PO components can include other plastics in an amount in the range of from 2 to 35 weight percent, 5 to 30 weight percent, or 10 to 25 weight percent, based on the total weight of the stream. The amount of non-plastic components can be at 2, at least 5, at least 10, at least 15, at least 20, at least 30, at least 40, at least 50, or 55 weight percent and/or not more than 70, not more than 60, not more than 50, not more than 40, not more than 30, not more than 20, not more than 15, not more than 10, not more than 7, or not more than 5 weight percent, based on the total weight of mixed plastic waste.

In the plastics processing facility 12, the MPW can be separated to removing non-PO plastic and/or non-plastic components (e.g., glass, metal, cardboard and paper, and dirt and sand) from the waste plastic. Such separation can be performed mechanically and can include utilize a fluid such as air. In one embodiment or in combination with any other mentioned embodiments, the separation may include a sink-float step where different types of plastic are separated by density, usually using water or a pH-controlled liquid (e.g., caustic solution). In one embodiment or in combination with any other mentioned embodiments, the separation may include use of a hydrocyclone.

As a result, the predominantly PO waste plastic can include at least 50, at least 55, at least 60, at least 65, at least 70, at least 75, at least 80, at least 85, at least 90, at least 95, at least 97, at least 99, at least 99.5, or at least 99.9 weight percent PO, based on the total weight of plastic in the predominantly PO waste plastic stream. This stream may also include not more than 1, not more than 0.5, or not more than 0.1 weight percent polyvinyl chloride (PVC) and PET in an amount of not more than 5, not more than 2, not more than 1, or not more than 0.5 weight percent, based on the total weight of the predominantly PO waste plastic.

In one embodiment or in combination with any other mentioned embodiments, at least a portion of the non-PO (or PET) waste plastic can itself be chemically recycled in the same or a different chemical recycling facility 10. Examples of chemical recycling processes to which the non-PET (or PO) waste plastic can be subjected include, but are not limited to, solvolysis, molecular reforming, and combinations thereof.

As shown in FIG. 1, the predominantly PO waste plastic stream can be introduced into a pyrolysis facility 14 and pyrolyzed in at least one pyrolysis reactor (not shown). The pyrolysis reaction involves chemical and thermal decomposition of the sorted waste plastic introduced into the reactor. Although all pyrolysis processes may be generally characterized by a reaction environment that is substantially free of oxygen, pyrolysis processes may be further defined by other parameters such as the pyrolysis reaction temperature within the reactor, the residence time in the pyrolysis reactor, the reactor type, the pressure within the pyrolysis reactor, and the presence or absence of pyrolysis catalysts.

The pyrolysis reaction performed in the pyrolysis reactor can be carried out at a temperature of less than 700, less than 650, or less than 600° C. and/or at least 300, at least 350, or at least 400° C. The feed to the pyrolysis reactor can comprise, consists essentially of, or consists of waste plastic, and the feed stream can have a number average molecular weight (Mn) of at least 3000, at least 4000, at least 5000, or at least 6000 g/mole. If the feed to the pyrolysis reactor contains a mixture of components, the Mn of the pyrolysis feed is the average Mn of all feed components, based on the weight of the individual feed components. The waste plastic in the feed to the pyrolysis reactor can include post-consumer waste plastic, post-industrial waste plastic, or combinations thereof. In one embodiment or in combination with any other mentioned embodiments, the feed to the pyrolysis reactor comprises less than 5, less than 2, less than 1, less than 0.5, or about 0.0 weight percent coal and/or biomass (e.g., lignocellulosic waste, switchgrass, fats and oils derived from animals, fats and oils derived from plants, etc.). The feed to the pyrolysis reaction can also comprise less than 5, less than 2, less than 1, or less than 0.5, or about 0.0 weight percent of a co-feed stream, including steam and/or sulfur-containing co-feed streams.

The pyrolysis reactor can be or include a film reactor, a screw extruder, a tubular reactor, a stirred tank reactor, a riser reactor, a fixed bed reactor, a fluidized bed reactor, a rotary kiln, a vacuum reactor, a microwave reactor, or an autoclave. The reactor may also utilize a feed gas and/or lift gas for facilitating the introduction of the feed into the pyrolysis reactor. The feed gas and/or lift gas can comprise nitrogen and can comprise less than 5, less than 2, less than 1, or less than 0.5, or about 0.0 weight percent of steam and/or sulfur-containing compounds.

The pyrolysis reaction can involve heating and converting the waste plastic feedstock in an atmosphere that is substantially free of oxygen or in an atmosphere that contains less oxygen relative to ambient air. For example, the atmosphere within the pyrolysis reactor may comprise not more than 5, not more than 4, not more than 3, not more than 2, not more than 1, or not more than 0.5 weight percent of oxygen.

The temperature in the pyrolysis reactor can be adjusted to facilitate the production of certain end products. In one embodiment or in combination with any other mentioned embodiments, the peak pyrolysis temperature in the pyrolysis reactor can be at least 325° C., or at least 350° C., or at least 375° C., or at least 400° C. Additionally or alternatively, the peak pyrolysis temperature in the pyrolysis reactor can be not more than 800° C., not more than 700° C., or not more than 650° C., or not more than 600° C., or not more than 550° C., or not more than 525° C., or not more than 500° C., or not more than 475° C., or not more than 450° C., or not more than 425° C., or not more than 400° C. More particularly, the peak pyrolysis temperature in the pyrolysis reactor can range from 325 to 800° C., or 350 to 600° C., or 375 to 500° C., or 390 to 450° C., or 400 to 500° C.

The residence time of the feedstock within the pyrolysis reactor can be at least 1, or at least 5, or at least 10, or at least 20, or at least 30, or at least 60, or at least 180 seconds. Additionally, or alternatively, the residence time of the feedstock within the pyrolysis reactor can be less than 2, or less than 1, or less than 0.5, or less than 0.25, or less than 0.1 hours. More particularly, the residence time of the feedstock within the pyrolysis reactor can range from 1 second to 1 hour, or 10 seconds to 30 minutes, or 30 seconds to 10 minutes.

The pyrolysis reactor can be maintained at a pressure of at least 0.1, or at least 0.2, or at least 0.3 barg and/or not more than 60, or not more than 50, or not more than 40, or not more than 30, or not more than 20, or not more than 10, or not more than 8, or not more than 5, or not more than 2, or not more than 1.5, or not more than 1.1 barg. The pressure within the pyrolysis reactor can be maintained at atmospheric pressure or within the range of 0.1 to 60, or 0.2 to 10, or 0.3 to 1.5 barg.

The pyrolysis reaction in the reactor can be thermal pyrolysis, which is carried out in the absence of a catalyst, or catalytic pyrolysis, which is carried out in the presence of a catalyst. When a catalyst is used, the catalyst can be homogenous or heterogeneous and may include, for example, certain types of zeolites and other mesostructured catalysts.

A recycled content pyrolysis effluent (r-pyrolysis effluent) stream withdrawn from the pyrolysis reactor can be separated to form a recycled content pyrolysis residue (r-pyrolysis residue) and streams of recycled content pyrolysis gas (r-pygas) and recycled content pyrolysis oil (r-pyoil), as generally shown in FIG. 1. As used herein, the term “r-pyrolysis residue” refers to a composition obtained from waste plastic pyrolysis that comprises predominantly pyrolysis char and pyrolysis heavy waxes. As used herein, the term “pyrolysis char” refers to a carbon-containing composition obtained from pyrolysis that is solid at 200° C. and 1 atm. As used herein, the term “pyrolysis heavy waxes” refers to C20+ hydrocarbons obtained from pyrolysis that are not pyrolysis char, pyrolysis gas, or pyrolysis oil. Additionally, as used herein, the term “r-pygas” refers to a composition obtained from waste plastic pyrolysis that is gaseous at 25° C. at 1 atm. As used herein, the terms “r-pyoil” refers to a composition obtained from waste plastic pyrolysis that is liquid at 25° C. and 1 atm.

As shown in FIG. 1, all or a portion of at least one stream from the pyrolysis facility 14 (e.g., the r-pygas and/or r-pyoil) can be introduced into a cracking facility, wherein the stream can be cracked to form lighter hydrocarbon products. The cracking facility generally includes a cracker furnace 16 for thermally cracking a hydrocarbon-containing feed stream, a quench zone 18 for cooling the cracked effluent, a compression zone 20 for increasing the pressure of the cooled, cracked stream, and a separation zone 22 for separating the compressed stream one or more recycled content hydrocarbon product (r-hydrocarbon product) streams from the compressed effluent. Examples of r-product streams can include, but are not limited to, recycled content ethylene (r-ethylene), recycled content ethane (r-ethane), recycled content propylene (r-propylene), recycled content propane (r-propane), recycled content butylene (r-butylene), recycled content butane (r-butane), and recycled content C5 and heavier (r-C5+).

In one embodiment or in combination with any other mentioned embodiments, as shown in FIG. 1, at least a portion of the r-pyoil can be introduced into the cracker furnace 16 alone or in combination with the hydrocarbon feed stream. The hydrocarbon feed stream introduced into the cracker furnace 16 as shown in FIG. 1 may comprise predominantly C2 to C4 hydrocarbon components, predominantly C2 hydrocarbon components, or predominantly C3 hydrocarbon components. The hydrocarbon feed stream can include at least 60, at least 70, at least 80, at least 95, or at least 95 weight percent of C2 to C4 hydrocarbon components. As used herein, the term “predominantly” means at least 50 weight percent. In such cases, the hydrocarbon-containing feed stream may be in the gas phase and the cracker furnace 16 may be considered a gas cracker furnace.

In one embodiment or in combination with any other mentioned embodiments, the hydrocarbon feed stream introduced into the cracker furnace 16 may comprise predominantly C5 to C22 hydrocarbon components, or predominantly C5 to C20 components, or predominantly C5 to C18 components, or it can include at least 60, at least 70, at least 80, at least 90, or at least 95 weight percent of C5 to C22 components. In such cases, the hydrocarbon feed stream may be in the liquid phase and the cracker furnace 16 may be considered a liquid cracker furnace. Alternatively, at least a portion of the furnace coils in the cracker furnace 16 may be configured to receive and process a gas phase hydrocarbon feed and at least a portion of the furnace coils in the cracker furnace 16 may be configured to process a liquid hydrocarbon feed so that the cracker furnace 16 may be considered a split furnace.

The cracking reaction performed in the cracker furnace 16 can be carried out at a temperature of at least 700, at least 750, at least 800, or at least 850° C. The feed to the cracker furnace 16 can have a number average molecular weight (Mn) of less than 3000, less than 2000, less than 1000, or less than 500 g/mole. If the feed to the pyrolysis reactor contains a mixture of components, the Mn of the cracker feed is the average Mn of all feed components, based on the weight of the individual feed components. The feed to the cracker furnace 16 can include virgin (i.e., not recycled) feedstock and can comprise less than 5, less than 2, less than 1, less than 0.5, or 0.0 weight percent of coal, biomass, and/or other solids. In one embodiment or in combination with any other mentioned embodiments, a co-feed stream, such as steam or a sulfur-containing stream (for metal passivation) cam be introduced into the cracker furnace 16. The cracker furnace 16 can include both convection and radiant sections and can have a tubular reaction zone. Typically, the residence time of the streams passing through the reaction zone (from the convection section inlet to the radiant section outlet) can be less than 20 seconds, less than 15 seconds, or less than 10 seconds.

In one embodiment or in combination with any other mentioned embodiments, the hydrocarbon-containing feed stream introduced into the cracker furnace 16 can comprise a recycled content hydrocarbon feed (r-HC feed). The r-HC feed can directly or indirectly include recycled content from waste plastic. In one embodiment or in combination with any other mentioned embodiments, the hydrocarbon feed may also include non-recycled content hydrocarbon, or it may include no recycled content hydrocarbon.

The cracked effluent withdrawn from the outlet of the cracker furnace 16 can comprise predominantly C4 and lighter (C3 and lighter, or C2 and lighter) components, or it can include least 55, at least 60, at least 70, at least 75, at least 80, at least 85, at least 90, or at least 95 weight percent of C4 and lighter (C3 and lighter, or C2 and lighter) components. In one embodiment or in combination with any other mentioned embodiments, the cracked effluent stream can include at least 20, at least 25, at least 30, at least 35, or at least 40 and/or not more than 65, not more than 60, not more than 55, or not more than 50 weight percent olefins, with at least 50, at least 60, at least 70, at least 80, at least 85, at least 90, or at least 95 weight percent of C3 (or C2) olefins, based on the total weight of olefins in the stream.

As shown in FIG. 1, the cracked hydrocarbon effluent stream may be cooled in a quench section 18 via direct or indirect heat exchange. The quenching step can reduce the temperature of the cracked effluent stream by at least 600, at least 650, at least 700, at least 750, or at least 800° F. and/or not more than 1000, not more than 950, not more than 900, not more than 850, or not more than 800° F. The temperature of the cracked effluent introduced into the quench zone 18 can be at least 900, at least 950, at least 1000, or at least 1050° F. and/or not more than 1125, not more than 1100, not more than 1050, or not more than 1000° F., while the temperature of the cooled cracked effluent withdrawn from the quench zone 18 can be at least 100, at least 150, or at least 200° F. and/or not more than 350, not more than 300, not more than 250, or not more than 200° F.

As shown in FIG. 1, the cooled cracked stream may then be compressed in a compression zone 20 via passage through 1 to 10, 2 to 8, or 3 to 6 compression stages with interim cooling and knockout equipment. The resulting compressed stream may then be separated in the separation zone 22 to provide one or more r-hydrocarbon products as discussed previously.

As also shown in FIG. 1, in one embodiment or in combination with any other mentioned embodiments, at least a portion of the r-pygas from the pyrolysis facility 14 may be introduced into the cracking facility in at least one location downstream of the cracker furnace 16 such as, for example, upstream or in the compression zone 20, upstream of the separation zone 22, or anywhere within the separation zone 22 upstream of one or more separation columns.

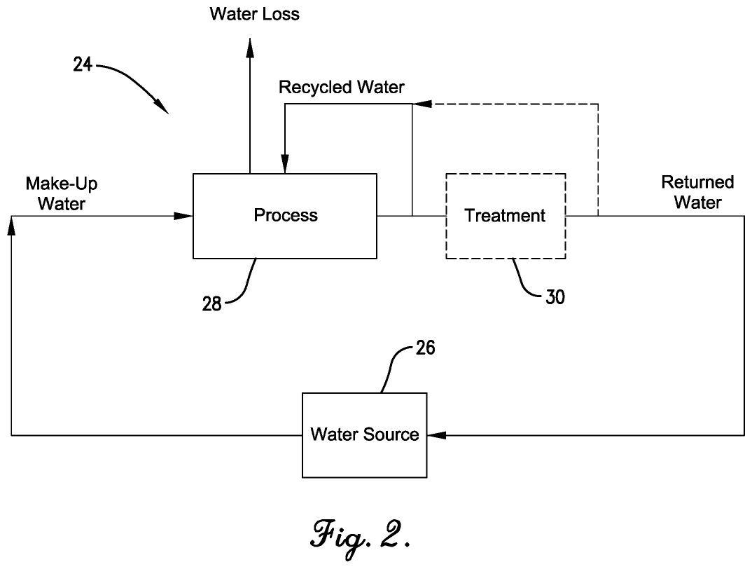

Turning now to FIG. 2, a schematic block flow diagram of a water system 24 used by a chemical recycling facility 10, such as the facility shown in FIG. 1, is provided. In general, as shown in FIG. 2, the water system 24 includes a water source 26 and a process 28, as well as one or more treatment steps/facilities. As shown in FIG. 2, fresh or make-up water from a water source 26 (usually a surface water source such as a lake, pond, stream, or river) can optionally be treated in a treatment zone 30 to remove undesirable components, and the treated water can then be provided to a process facility 28 (e.g., the chemical recycling facility or at least one of the plastics processing, pyrolysis, and cracking facilities). Within the process facility 28, the water can be used in one or more locations, such as, for example at least one cooling tower to remove heat from the process/facility and/or at least one steam user to provide heat to the process/facility. In one embodiment or in combination with any other mentioned embodiments, at least a portion of the water can be used to generate steam, to cool one or more process streams (directly or indirectly) and/or in one or more process steps (e.g., to conduct a sink-float separation in the plastics processing facility 12).

As shown in FIG. 2, at least a portion of the water from the water system 24 may be lost to the environment. Examples of environmental loss include evaporative loss from a cooling tower, steam or water loss through piping and equipment leaks, and water lost through various drying steps/equipment (e.g., spent molecular sieve). Typically, the daily average flow rate of water loss from a chemical recycling facility 10 (or one or more of the individual facilities within the chemical recycling facility 10) can be less than 20, less than 15, less than 10, less than 5, less than 2, or less than 1 percent of the daily average mass flow rate of make-up or fresh water added to the system. All flow rates described herein are mass flow rates, unless otherwise noted.

As the water circulates throughout the water system 24 within the process/facility, at least a portion may be removed from the system for further treatment in a downstream water treatment facility. In one embodiment or in combination with any other mentioned embodiments, this type of treatment facility 30 (e.g., a wastewater facility) may utilize one or more water treatment chemicals that can be added to the water control the pH and/or mineral content of the water and/or to eliminate biological organisms. After being treated, all or a portion of the water can then be recycled back to the process facility 28, and/or a portion or all can be returned to the water source 26, as shown in FIG. 2. In one embodiment or in combination with any other mentioned embodiments, the daily average mass flow rate of returned water to the water source can be at least 15, at least 20, at least 25, or at least 30 and/or not more than 65, not more than 60, not more than 55, not more than 50, or not more than 45 percent of the daily average mass flow rate of the water recirculating within the water system 26 of the process facility.

Thus, the water consumption of a chemical recycling facility 10 can include make-up water demand, water loss to the environment, and water returned to the water source 26, as well as specific elements such as cooling tower heat load (which is a source of water loss via evaporation), steam consumption (which correlates with make-up water demand), and, in a cracking facility, amount of water added to the hydrocarbon feed as dilution steam (which relates to both make-up water demand and water returned to the surface source).

In one embodiment or in combination with any other mentioned embodiments, pyrolysis and/or cracking facilities as described herein may exhibit a lower water consumption than other similar facilities. For example, one or more modifications to new or existing pyrolysis and/or cracking facilities may result in a modified facility meeting at least one (two, three, four, five, or six) of the following criteria:
(i) a reduction in the daily average flow rate of make-up water of at least 0.5, at least 1, at least 5, at least 10, at least 20, at least 25, at least 30, at least 35, at least 40, at least 45, or at least 50 percent, as compared to the facility prior to modification, all other things being equal;
(ii) a reduction in the daily average flow rate of water loss of at least 0.5,at least 1, at least 5, at least 10, at least 20, at least 25, at least 30, at least 35, at least 40, at least 45, or at least 50 percent, as compared to the facility prior to modification, all other things being equal;
(iii) a reduction in the daily average flow rate of water returned to the water source of at least 0.5, at least 1, at least 5, at least 10, at least 20, at least 25, at least 30, at least 35, at least 40, at least 45, or at least 50 percent, as compared to the facility prior to modification, all other things being equal;
(iv) a reduction in the daily average heat load of the cooling tower of at least 0.5, at least 1, at least 5, at least 10, at least 20, at least 25, at least 30, at least 35, at least 40, at least 45, or at least 50 percent, as compared to the facility prior to modification, all other things being equal;
(v) a reduction in the daily average flow rate of steam consumed by the steam users of at least 0.5, at least 1, at least 5, at least 10, at least 20, at least 25, at least 30, at least 35, at least 40, at least 45, or at least 50 percent, as compared to the facility prior to modification, all other things being equal; and
(vi) when the facility is a cracking facility, a reduction in the daily average flow rate of dilution steam added to the cracker furnace of at least 0.5, at least 1, at least 5, at least 10, at least 20, at least 25, at least 30, at least 35, at least 40, at least 45, or at least 50 percent, as compared to the facility prior to modification, all other things being equal.

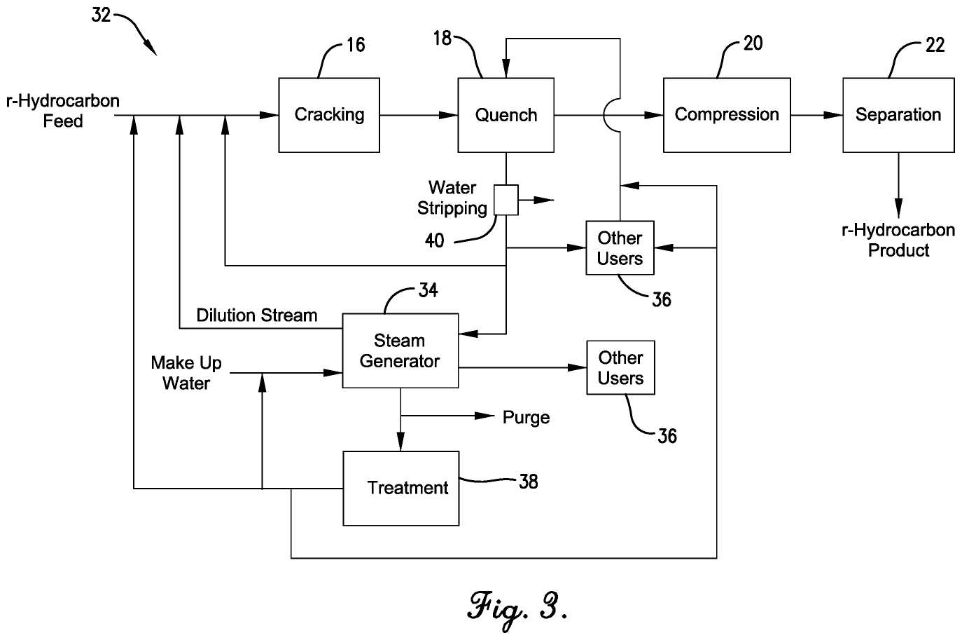

In one embodiment or in combination with any other mentioned embodiments, the modifications to the pyrolysis and/or cracking facilities to achieve reduced water consumption can be done to existing pyrolysis and/or cracking facilities (e.g., a retrofit) and/or the modifications may be done during the design of a new facility such that the new facility is constructed with the modifications. In one embodiment or in combination with any other mentioned embodiments, the modifications may be part of a larger modification to a new or existing facility to permit the facility to process mixed plastic waste and/or one or more streams derived from mixed plastic waste, rather than only process traditional petroleum-based or petroleum-derived non-recycled content feedstocks. Several embodiments of pyrolysis and/or cracking facilities with lower water consumption as compared to similar unmodified facilities are described with respect to FIGS. 3-6b below.

Turning now to FIG. 3, a block flow diagram illustrating the main process steps/zones of a water system 32 suitable for use in a cracking facility according to various embodiments of the present invention is shown. As described with respect to FIG. 1, a recycled content hydrocarbon feed (r-hydrocarbon feed) stream introduced into a cracker furnace 16 is thermally cracked to form a recycled content cracked effluent (r-cracked effluent) stream, which is cooled in a quench zone 18. In one embodiment or in combination with any other mentioned embodiments, at least a portion of the cooling in the quench zone 18 is carried out in an indirect (e.g., fin or shell-and-tube) heat exchanger, while, in other cases, at least a portion is carried out by directly contacting the r-cracked effluent stream with a quench liquid. The resulting cooled cracked hydrocarbon stream withdrawn from the quench zone 18 can then be compressed in a compression zone 20 and the compressed stream may then be separated in the separation zone 22 to provide one or more r-hydrocarbon products, as discussed previously.

As shown in FIG. 3, water can be introduced into a steam generator 34 in the cracking facility, wherein it can be heated to generate steam. In one embodiment or in combination with any other mentioned embodiments, the steam generator 34 may vaporize recycled process water and/or it may vaporize fresh make-up water from a water source (not shown). In one embodiment or in combination with any other mentioned embodiments, as shown in FIG. 3, the steam generator may vaporize both recycled and fresh make-up water. As shown in FIG. 3, at least a portion of the steam may be used as dilution steam and combined with the r-hydrocarbon feed introduced into the cracker furnace 16, while at least a portion may be routed to other steam users 36 within the facility. In one embodiment or in combination with any other mentioned embodiments, at least 30, at least 35, at least 40, or at least 45 and/or not more than 75, not more than 70, not more than 65, or not more than 60 percent of the total daily average mass flow rate of steam withdrawn from the steam generator 34 can be used as dilution steam. The steam-to-hydrocarbon ratio in the r-hydrocarbon feed to the cracker furnace 16 can be at least 0.2:1, at least 0.25:1, at least 0.30:1, at least 0.35:1, at least 0.40:1, at least 0.45:1, at least 0.50:1, at least 0.55:1, at least 0.60:1, or at least 0.65:1 and/or not more than 0.90:1, not more than 0.85:1, not more than 0.80:1, not more than 0.75:1, or not more than 0.70:1, by weight.

As shown in FIG. 3, in one embodiment or in combination with any other mentioned embodiments, a blowdown stream may be withdrawn from the steam generator 34. As used herein, the term “blowdown stream” refers to a stream of water removed from a boiler to control the concentration of impurities and other chemicals in the water being evaporated to form steam. Too high of a concentration of impurities and other chemicals can minimize efficiency, as well as damage downstream equipment through scaling and corrosion. In one embodiment or in combination with any other mentioned embodiments, at least a portion of the blowdown stream may be purged from the system, and another portion may be further treated 38 as shown in FIG. 3. Examples of treatment steps 38 can include, but are not limited to, filtration and/or ion exchange. When treated, the impurity content and/or concentration of one or more chemicals can be adjusted so that the resulting purified water can be returned to the system as shown in FIG. 3. Most typically, the entirety of the blowdown stream is treated in another water treatment facility 38 and then returned to the water source 26 as shown in FIG. 2.

In one embodiment or in combination with any other mentioned embodiments, the pH of the treated blowdown stream can be at least 6.5, at least 7, at least 7.5 and/or not more than 12, not more than 11.5, not more than 11, or not more than 10.5. The treated blowdown stream may also include relatively low amounts of impurities and/or boiler chemicals such as, for example, at least 0.01, at least 0.02, at least 0.05, or at least 0.10 weight percent and/or not more than 1.5, not more than 1.0, not more than 0.8, not more than 0.5, or not more than 0.2 weight percent.

Examples of impurities present in the blowdown stream can include, but are not limited to, one or more compounds selected from the group consisting of sodium hydroxide, potassium hydroxide, calcium carbonate, amines, oxygen scavengers, silicates, phosphates, ammonia, and sodium thiosulfate. Examples of boiler chemicals can include but are not limited to various corrosion additives, pH control additives, and combinations thereof. The impurities and/or boiler chemicals can include at least one ion selected from the group consisting of barium, sodium, iron, calcium, magnesium, potassium, silicon, aluminum, nickel, cobalt, amine, silicate, chloride, bicarbonate, carbonate, sulfate, thiosulfate, bisulfite, sulfite, sulfide, bisulfide, and phosphate.

In addition to the blowdown stream, at least a portion of the condensate from the steam users of the facility can also be introduced into the treatment section, wherein the stream may be treated as described above. In one embodiment or in combination with any other mentioned embodiments, all or a portion of the condensate may be returned to the inlet of the steam generator (embodiment not shown).

As shown in FIG. 3, at least a portion of the treated water stream can be routed to one or more water users 36 within the facility that require process water to operate. In one embodiment or in combination with any other mentioned embodiments, at least a portion of a quench water stream used to cool the cracked effluent from the cracker furnace can include at least a portion of the treated water stream. When introduced into the quench zone, the quench water stream can have a temperature of at least 30, at least 35, at least 40, or at least 45° C. and/or not more than 75, not more than 70, not more than 65, not more than 60, or not more than 55° C., and it may cool the cracked effluent by at least 200, at least 250, at least 300, or at least 350° F. and/or not more than 550, not more than 500, not more than 450, or not more than 400° F.

The resulting warmed quench water can then be withdrawn from the quench section 18 and passed through a water stripping zone 40, as shown in FIG. 3, to remove at least a portion of the organic compounds in the warmed quench water. At least a portion of the resulting stripped process water can then be routed to one or more other water users 36 within in or external to the cracking facility. In one embodiment or in combination with any other mentioned embodiments, as shown in FIG. 3, at least a portion of the stripped process water can also be introduced into the steam generator 34 to be vaporized to form steam. Additionally, the water introduced into the steam generator may include fresh water and/or water withdrawn from the treatment section 38.

As illustrated in FIG. 3 and as mentioned previously, at least a portion of the steam generated in the steam generator 34 can be used as dilution steam and combined with the r-hydrocarbon stream introduced into the cracking facility. In one embodiment or in combination with any other mentioned embodiments, at least a portion of the process or treated process water may also be combined with the r-hydrocarbon stream as liquid water, which can then be vaporized in or before the cracker furnace 16. In one embodiment or in combination with any other mentioned embodiments, the process or treated process water may originate from within the cracking facility, while, in other cases, at least a portion may originate from a different facility (e.g., a pyrolysis facility 14 and/or a plastics processing facility 12).

When water is combined with the r-hydrocarbon stream introduced into the cracker furnace, at least a portion or all of the stream may be liquid. In one embodiment or in combination with any other mentioned embodiments, the amount of liquid in the process or treated water stream combined with the r-hydrocarbon stream can be not more than 50, not more than 45, not more than 40, not more than 35, not more than 30, not more than 25, not more than 20, not more than 15, not more than 10, not more than 5, not more than 2, or not more than 1 weight percent, based on the total weight of the water stream added to the r-hydrocarbon stream.

When combined with the r-hydrocarbon stream, the temperature of the treated or process water can be at least 50, at least 75, at least 100, at least 125 and/or not more than 175, not more than 150, not more than 125, or not more than 100° C., and the pressure of the stream can be at least 50, at least 60, at least 70, or at least 80 pounds per square inch gauge (psig) and/or not more than 125, not more than 115, not more than 100, or not more than 95 psig. In one embodiment or in combination with any other mentioned embodiments, the amount, temperature, and/or pressure of the process or treated water added to the r-hydrocarbon stream may help adjust the temperature at the cross-over section between the convection and radiant sections of the cracker furnace (not shown). This may help adjust the yield of specific hydrocarbon components in the cracked effluent stream recovered from the furnace 16.

Additionally, including at least some liquid process and/or treated water in the r-hydrocarbon feed may help reduce the amount of dilution steam needed to maintain temperatures within the cracker furnace 16. In one embodiment or in combination with any other mentioned embodiments, the amount of dilution steam added to the r-hydrocarbon stream can be reduced by at least 1, at least 5, at least 10, at least 15, at least 20, at least 25, at least 30, at least 35, at least 40, at least 45, or at least 50 percent less than when no liquid water is added to the r-hydrocarbon stream. In one embodiment or in combination with any other mentioned embodiments, the cracking facility can have a reduction in water consumption, as defined by at least one, at least two, at least three, at least four, at least five, or all of the criteria (i) through (vi) above (e.g., reduction in make-up water demand, reduction in water loss, reduction in returned water, reduction in steam consumption, reduction in cooling tower load, and reduction in dilution steam to the cracker furnace) when at least some liquid water is added to the r-hydrocarbon stream introduced into the cracker furnace 16, as compared to when no liquid water is added to the r-hydrocarbon stream, all other things being equal.

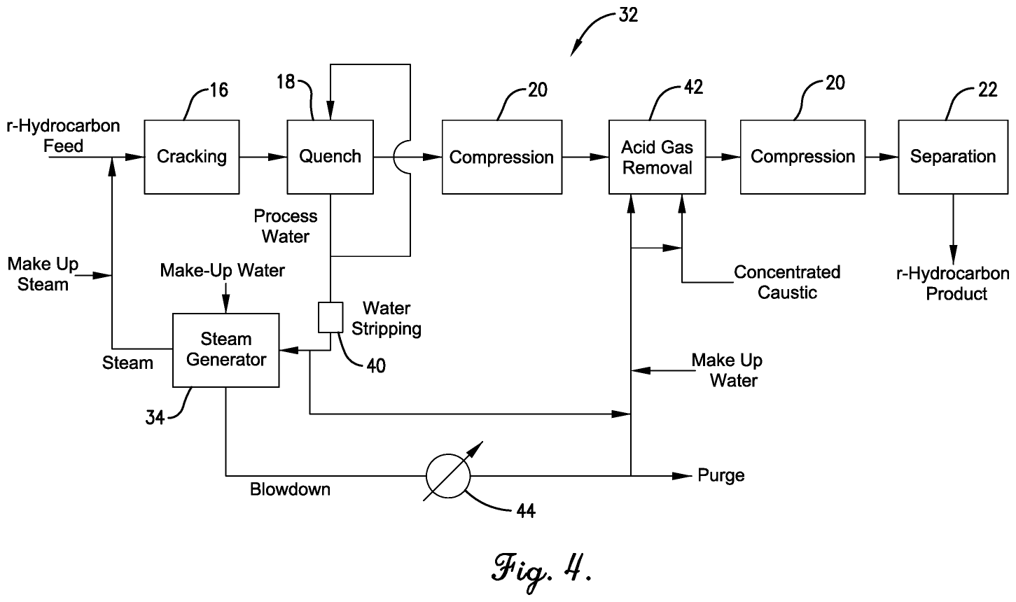

Turning now to FIG. 4, a block flow diagram illustrating the basic process steps/zones of a water system 32 of a cracking facility according to additional embodiments of the present invention is shown. As shown in FIG. 4, a cooled, compressed cracked hydrocarbon stream withdrawn from at least a portion of the compression zone 20 sent to an acid gas removal zone 42, wherein at least a portion of the acid gas components can be removed. As used herein, the term “acid gas” refers to a gas which, upon combination with water, has a pH of less than 7. Examples of acid gases can include, but are not limited to, carbon dioxide (CO2), carbon monoxide (CO), nitrogen oxides (NOx), sulfur oxides (SOx), and hydrogen sulfide (H2S). As shown in FIG. 4, the treated gas stream can be further compressed 20 before being separated into one or more r-hydrocarbon products as described herein.

As also shown in FIG. 4, the process water removed from the quench zone 18 can optionally be treated (e.g., stripped) 40 to remove organic impurities, and the resulting stream can be returned to the steam generator 34, wherein it can be vaporized (along with fresh make-up water) to form steam, which can be combined with the r-hydrocarbon feed as dilution steam. In one embodiment or in combination with any other mentioned embodiments, make-up steam can also be added to the steam withdrawn from the generator 34 in order to achieve a steam-to-hydrocarbon ratio within the ranges provided herein.

As shown in FIG. 4, a blowdown stream withdrawn from the steam generator 34 can be cooled 44 and at least a portion of the cooled stream may then be routed to the acid gas removal zone 42 for use in contacting the compressed cracked gas to remove at least a portion of the acid gas components. In one embodiment or in combination with any other mentioned embodiments, prior to the cooling, the blowdown stream can have a temperature of at least 55, at least 60, at least 65, or at least 70° C. and/or not more than 95, not more than 90, not more than 85, not more than 80, not more than 75, or not more than 70° C., and the cooled blowdown stream can have a temperature of at least 35, at least 40, at least 45, or at least 50° C. and/or not more than 65, not more than 60, not more than 55, or not more than 50° C.

In one embodiment or in combination with any other mentioned embodiments, as shown in FIG. 4, at least a portion of the treated (stripped) process water fed into the steam generator 34 and/or at least a portion of a blowdown stream withdrawn from the steam generator 34 can be introduced into the acid gas removal zone 42 of the cracking facility. Optionally, the treated process water and/or blowdown water can be combined with make-up water and the combined stream introduced into a caustic tower in the acid gas removal zone 42. At least a portion of the blowdown stream may be purged.

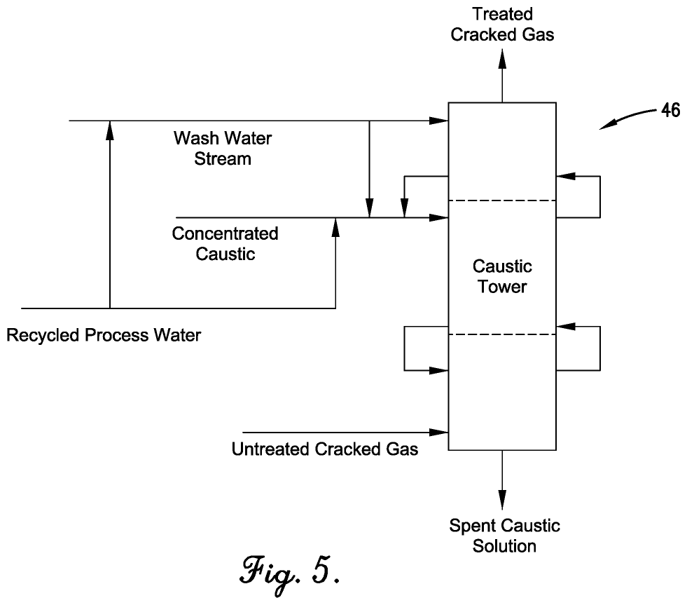

Turning now to FIG. 5, one example of a caustic tower 46 suitable for use in an acid gas removal zone of a cracking facility is shown. As shown in the embodiment depicted in FIG. 5, the caustic tower 46 is a multi-stage, counter-current wash tower having an inlet for the untreated cracked gas near the bottom of the tower and an outlet for the treated cracked gas near the top of the tower. A wash water stream can be introduced near the top of the tower and may contact the ascending cracked vapor to remove acid gas components. The spent liquid from the uppermost water contacting stage may be combined with a fresh caustic stream to form a dilute caustic stream, which may contact the ascending vapor in the middle section of the tower. Again, the spent caustic may be used for additional gas contact in the lower section of the tower before being removed as spent caustic solution from the bottom. In one embodiment or in combination with any other mentioned embodiments, at least a portion of the wash water stream may also be used to dilute the concentrated caustic before entering the caustic contacting portion of the tower.

When introduced into the caustic tower 46, at least a portion of the recycled process water can be introduced into or as the wash water stream and/or at least a portion may be added to the concentrated caustic stream to form a diluted caustic stream. As shown in FIG. 4, the recycled process water can include at least a portion of the process water removed from the quench zone 18 (optionally after being treated to remove organics) and/or at least a portion of the blowdown stream removed from the steam generator 34.

In one embodiment or in combination with any other mentioned embodiments, the concentrated caustic stream introduced into the caustic tower 46 as shown in FIG. 5 can include at least 10, at least 15, at least 20, at least 25, at least 30, at least 35, at least 40, or at least 45 weight percent and/or not more than 60, not more than 55, not more than 50, not more than 45, or not more than 40 weight percent of sodium hydroxide or potassium hydroxide, while the diluted caustic can include less than 25, less than 20, less than 15, less than 10, less than 8, less than 6, less than 5, or less than 2 weight percent of sodium or potassium hydroxide. When the recycled water (e.g., treated process water and/or blowdown water) are used to dilute the concentrated caustic, the dilution can be performed just upstream or within the caustic tower 46.

In one embodiment or in combination with any other mentioned embodiments, contacting the cracked gas stream with caustic and wash water in the caustic tower 46 can reduce the amount of acid gas components in the untreated cracked gas stream by at least 50, at least 60, at least 70, at least 75, at least 80, at least 90, at least 95, or at least 99 percent as compared to the amount of acid gas components introduced into the caustic tower in the untreated gas feed. The untreated cracked gas introduced into the caustic tower 46 may comprise at least 1, at least 5, at least 10, at least 15, at least 20, or at least 25 weight percent of one or more acid gas components. As discussed previously, acid gas components can be selected from the group consisting of carbon dioxide (CO2), carbon monoxide (CO), nitrous oxides (NOx), sulfur oxides (SOx), and combinations thereof. In one embodiment or in combination with any other mentioned embodiments, the treated gas stream removed from the caustic tower 46 can have a total acid gas content of not more than 1, not more than 0.5, not more than 0.25, not more than 0.10, not more than 0.05, or not more than 0.01 mole percent.

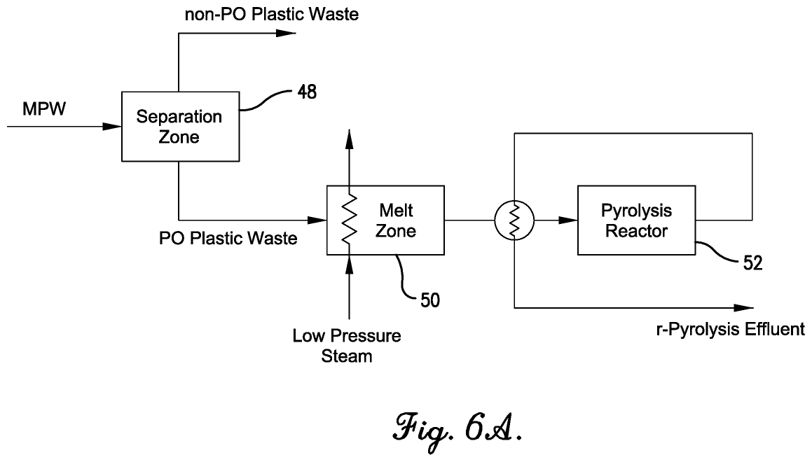

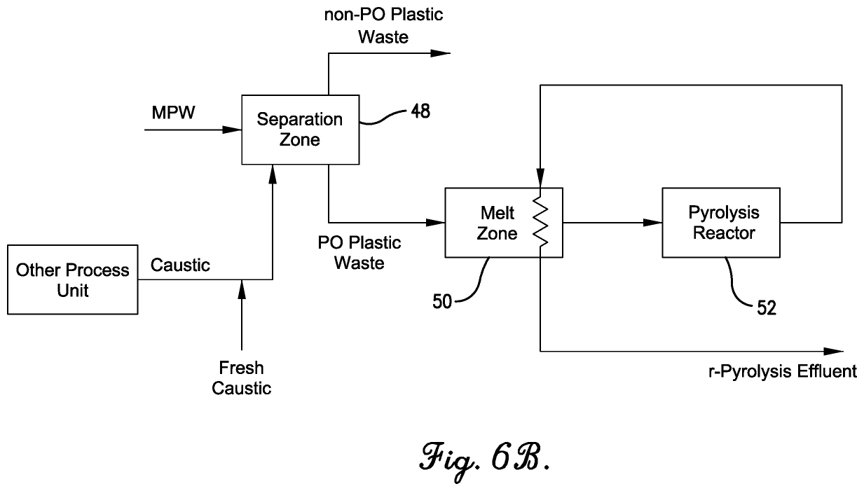

Turning now to FIGS. 6a and 6b, portions of a chemical recycling facility 10 configured for reduced water consumption according to further embodiments of the present technology are shown, and particularly illustrating integration of a plastics processing step/facility and a pyrolysis step/facility. In the embodiments shown in FIGS. 6a and 6b, the plastics processing step/facility includes a separation zone 48 for separating mixed plastic waste into a PO plastic waste stream and a non-PO plastic waste stream and a pyrolysis facility 14 including a melt (liquefaction) zone 50 for liquifying the PO waste plastic and a pyrolysis reactor 52 for pyrolyzing the liquified waste plastic to form a recycled content pyrolysis effluent (r-pyrolysis effluent) stream. Additional details regarding the operation and configuration of the plastics processing step/facility and the pyrolysis step/facility are discussed previously with respect to FIG. 1.

Referring initially to FIG. 6a, mixed plastic waste separated in the plastics processing facility 12 can be liquified (e.g., melted) in the liquification zone (e.g., melt zone) 50 to provide a liquified PO waste plastic, which can be introduced into the pyrolysis reactor 52. In one embodiment or in combination with any other mentioned embodiments (not shown in FIG. 6a), the liquified PO waste plastic may be further heated via indirect heat exchange with a heat transfer medium (such as steam) prior to introduction into the pyrolysis reactor 52. However, by warming the feed stream to the pyrolysis reactor 52 via indirect heat exchange with the r-pyrolysis effluent stream, the pyrolysis facility 14 may reduce steam consumption, thereby reducing water consumption. At the same time, using the feed stream to cool the r-pyrolysis effluent may also help reduce the cooling tower load, thereby reducing the water loss from the facility. In one embodiment or in combination with any other mentioned embodiments, this may also increase energy efficiency, and result in lower operating costs and less environmental impact.

Additionally, or in the alternative, at least a portion of the heating performed in the liquification (e.g., melt) zone 50 can be carried out using low-pressure steam having a nominal pressure less than 100 pounds per square inch (psig), or it can be less than 75, or less than 50 psig. Such steam may have initially had a higher pressure and may have been previously utilized in another process step or facility (e.g., in a heat exchanger or in a steam-driven turbine). The resulting lower pressure steam may then be used in the liquification zone to provide heat to the PO waste plastic. Typically, such heat can be provided to the PO waste plastic by a warmed heat transfer medium or other, higher-pressure steam directly out of the boiler, so utilizing lower pressure steam not only reduces water consumption, but also improves energy efficiency. In one embodiment or in combination with any other mentioned embodiments, one or more steam-driven pumps, turbines, or other type of equipment can be replaced with an electric driver, thereby saving additional steam usage and further reducing water consumption.

Referring now to FIG. 6b, a separation zone 48, liquification (e.g., melt) zone 50, and a pyrolysis reactor 52 similar to those shown in FIG. 6a are provided. In the configuration shown in FIG. 6b, at least a portion of the warm r-pyrolysis effluent may be used in the liquification zone 50 to heat the PO waste plastic, thereby reducing water consumption by reducing the amount of steam needed to heat the plastic (or to heat the heat transfer medium used to heat the plastic).

Additionally, in one embodiment or in combination with any other mentioned embodiments, at least a portion of a water stream (or dilute caustic stream) from one or more other process units in or outside of the pyrolysis facility 14 (e.g., the cracking facility) may be used in the separation zone 48 of the plastics processing facility 12, particularly when the separation zone utilizes a sink-float separation step. In one embodiment or in combination with any other mentioned embodiments, the sink-float step can be performed in a density-controlled liquid, such as caustic, having a density of at least 1.2, at least 1.25, or at least 1.3 grams per centimeter cubed (g/cm³). In one embodiment or in combination with any other mentioned embodiments, at least a portion of the caustic used in the sink-float separation step can originate in another process unit and/or in another process facility (e.g., a cracking facility). When an outside stream of caustic is combined with another dilute or concentrated caustic to form the density-controlled liquid, the cations in each of the two streams can be the same. Examples of suitable cations can include, but are not limited to, sodium (Na⁺) and potassium (K⁺).

In other cases, the separating step can be modified so that at least a portion of the separating is performed in the absence of a liquid. Instead, pressurized air or another fluid may be used, or the plastics can be separated manually or with an automated separation device.

In one embodiment or in combination with any other mentioned embodiments, integrating at least a portion of the water systems of two or more of co-located plastics processing, pyrolysis, and cracking facilities can reduce the total water consumption of the integrated facility by at least 1, at least 5, at least 10, at least 15, at least 20, at least 25, at least 30, at least 35, at least 40, at least 45, or at least 50 percent as compared to the total water consumption if the facilities were not integrated, all other things being equal. For example, in one embodiment or in combination with any other mentioned embodiments, the integrated facilities meet at least one (at least two, at least three, at least four, at least five, or all) of the following criteria (i) through (vi):
(i) a reduction in the daily average flow rate of make-up water of at least 0.5, at least 1, at least 5, at least 10, at least 20, at least 25, at least 30, at least 35, at least 40, at least 45, or at least 50 percent, as compared to the daily average flow rate of make-up water if the facilities were not integrated, all other things being equal;
(ii) a reduction in the daily average flow rate of water loss of at least 0.5, at least 1, at least 5, at least 10, at least 20, at least 25, at least 30, at least 35, at least 40, at least 45, or at least 50 percent, as compared to the daily average flow rate of water loss if the facilities were not integrated, all other things being equal;
(iii) a reduction in the daily average flow rate of returned water of at least 0.5, at least 1, at least 5, at least 10, at least 20, at least 25, at least 30, at least 35, at least 40, at least 45, or at least 50 percent, as compared to the daily average flow rate of returned water if the facilities were not integrated, all other things being equal;
(iv) a reduction in the daily average heat load of the cooling tower of at least 0.5, at least 1, at least 5, at least 10, at least 20, at least 25, at least 30, at least 35, at least 40, at least 45, or at least 50 percent, as compared to the daily average heat load of the cooling tower if the facilities were not integrated, all other things being equal;
(v) a reduction in the daily average flow rate of steam consumed by the steam users of at least 0.5, at least 1, at least 5, at least 10, at least 20, at least 25, at least 30, at least 35, at least 40, at least 45, or at least 50 percent, as compared to the daily average flow rate of steam consumed by the steam users if the facilities were not integrated, all other things being equal; and
(vi) when one of the facilities is a cracking facility, a reduction in the daily average flow rate of dilution steam added to the cracker furnace of at least 0.5,at least 1, at least 5, at least 10, at least 20, at least 25, at least 30, at least 35, at least 40, at least 45, or at least 50 percent, as compared to the daily average flow rate of dilution steam if the facilities were not integrated, all other things being equal.

When the integrated facilities include a pyrolysis facility 14 and/or a cracking facility, the pyrolysis facility 14 and/or the cracking facility can have an overall reduction in water consumption of at least 1, at least 5, at least 10,at least 15, at least 20, at least 25, at least 30, at least 35, at least 40, at least 45, or at least 50 percent, as compared to if the facilities were not integrated, all other things being equal.

### DEFINITIONS

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es).

As used herein, the term “co-located” refers to the characteristic of at least two objects being situated on a common physical site, and/or within 5 miles of each other.

As used herein, the term “commercial scale facility” refers to a facility having an average annual feed rate of at least 500 pounds per hour, averaged over one year.

As used herein, the terms “comprising,” “comprises,” and “comprise” are open-ended transition terms used to transition from a subject recited before the term to one or more elements recited after the term, where the element or elements listed after the transition term are not necessarily the only elements that make-up the subject.

As used herein, the term “cracking” refers to breaking down complex organic molecules into simpler molecules by the breaking of carbon-carbon bonds.

As used herein, the terms “including,” “include,” and “included” have the same open-ended meaning as “comprising,” “comprises,” and “comprise” provided above.

As used herein, the term “predominantly” means more than 50 percent by weight. For example, a predominantly propane stream, composition, feedstock, or product is a stream, composition, feedstock, or product that contains more than 50 weight percent propane.

As used herein, the term “pyrolysis” refers to thermal decomposition of a feedstock of a biomass and/or a plastic material in solid or liquid form at elevated temperatures in an inert (i.e., substantially molecular oxygen free) atmosphere.

As used herein, the term “pyrolysis effluent” refers to the outlet stream withdrawn from the pyrolysis reactor in a pyrolysis facility.

As used herein, the terms “pyrolysis gas” and “pygas” refer to a composition obtained from pyrolysis that is gaseous at 25° C.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the term “pyrolysis vapor” refers to the overhead or vapor-phase stream withdrawn from the separator in a pyrolysis facility used to remove r-pyrolysis residue from the r-pyrolysis effluent.

As used herein, the term “recycled content” refers to being or comprising a composition that is directly and/or indirectly derived from recycled material.

As used herein, the term “waste material” refers to used, scrap, and/or discarded material.

As used herein, the terms “waste plastic” and “plastic waste” refer to used, scrap, and/or discarded plastic materials.

### CLAIMS NOT LIMITED TO DISCLOSED EMBODIMENTS

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A process for producing a recycled content hydrocarbon product (r-hydrocarbon product), the process comprising:
(a) cracking a recycled content hydrocarbon feed (r-hydrocarbon feed) stream in a cracker furnace in a cracker facility to provide a cracked gas stream;
(b) quenching at least a portion of the cracked gas stream in a quench zone of the cracker facility to provide a cooled cracked gas stream;
(c) withdrawing a process water stream from the quench zone; and
(d) contacting at least a portion of the cooled cracked gas stream with at least a portion of the process water stream in an acid gas removal zone of the cracker facility, and, optionally,
further comprising, prior to the contacting of step (d), combining at least a portion of the process water with a stream of make-up water to provide a combined water stream, and wherein the contacting of step (d) includes contacting the cracked gas with the combined water stream.

2. The process of claim 1, further comprising, after the withdrawing of step (c), passing at least a portion of the process water stream through at least one stripping zone to provide a stripped process water stream, and wherein the contacting of step (d) includes contacting at least a portion of the cracked gas stream with at least a portion of the stripped water stream, and, optionally,
wherein the contacting of step (d) is carried out in a caustic tower.

3. The process of claim 2, further comprising, prior to the contacting of step (d), diluting a concentrated caustic stream with at least a portion of the process water stream to provide a diluted caustic stream, wherein the contacting of step (d) includes contacting the cracked gas stream with at least a portion of the diluted caustic stream in the caustic tower, and, optionally,
wherein the concentrated caustic stream comprises at least 10 and/or not more than 60 weight percent sodium hydroxide or potassium hydroxide, based on the total weight of the stream, and, optionally,
wherein the diluted caustic stream comprises less than 25 weight percent sodium hydroxide or potassium hydroxide, based on the total weight of the stream.

4. The process of claim 2, wherein the contacting of step (d) includes contacting the cooled cracked gas stream with a wash water stream in the caustic tower and wherein the wash water stream comprises at least a portion of the process water stream.

5. The process of claim 2, further comprising, after the withdrawing of step (c), introducing at least a portion of the process water into a steam generator to generate steam; and withdrawing a blowdown stream from the steam generator, wherein the contacting of step (d) includes contacting at least a portion of the cracked gas stream with at least a portion of the blowdown stream, and, optionally,
further comprising, prior to the contacting of step (d), diluting a concentrated caustic stream with at least a portion of the blowdown stream to provide a diluted caustic stream, wherein the contacting of step (d) includes contacting the cooled cracked gas stream with at least a portion of the diluted caustic stream in the caustic tower, and, optionally,
wherein the contacting of step (d) includes contacting the cooled cracked gas with a wash water stream comprising at least a portion of the blowdown stream in the caustic tower.

6. The process of claim 1, wherein at least a portion of the quenching of step (b) is carried out with at least one indirect heat exchanger or is carried out with at least one direct heat exchanger.

7. The process of claim 1, wherein the quenching of step (b) includes contacting at least a portion of the cracked gas stream with a quench water stream, wherein the process water stream withdrawn in step (c) includes at least a portion of the quench water stream, and, optionally, further comprising returning at least a portion of the process water stream back to the quench zone.

8. The process of claim 1, wherein the quenching reduces the temperature of the cracked gas stream by at least 400 and/or not more than 850° F., or
wherein the cracked gas stream introduced into the quench zone has a temperature of at least 900° F. and/or not more than 1125° F., or
wherein the cooled cracked gas stream has a temperature of at least 400° F. and/or not more than 650° F.

9. The process of claim 1, further comprising prior to at least a portion of the cracking of step (a), combining a hydrocarbon feed stream with dilution steam to form a combined stream and cracking at least a portion of the combined stream, and, optionally,
wherein the dilution steam comprises at least a portion of the process water withdrawn from the quench zone.

10. The process of claim 9, wherein the ratio of dilution steam to hydrocarbon in the combined stream is at least 0.25:1 and/or not more than 0.90:1, by weight, and, optionally,
wherein the dilution steam is formed in a steam generator in the cracking facility.

11. The process of claim 1, further comprising pyrolyzing waste plastic to form recycled content pyrolysis oil (r-pyoil) and/or recycled content pyrolysis gas (r-pygas), and wherein the r-hydrocarbon feed stream comprises at least a portion of the r-pygas and/or the r-pyoil, and, optionally,
further comprising introducing at least a portion of the r-pyoil into the cracker furnace, and, optionally,
further comprising introducing at least a portion of the r-pygas into a location downstream of the cracker furnace, and, optionally,
further comprising prior to the pyrolyzing, separating mixed plastic waste into a PET-enriched portion and a PO-enriched portion, wherein at least a portion of the PO-enriched portion is pyrolyzed.

12. The process of claim 11, wherein the r-hydrocarbon feed stream comprises predominantly C2 to C4 components, or wherein the r-hydrocarbon feed stream comprises at least 60 weight percent of C2 to C4 components, or
wherein the r-hydrocarbon stream comprises predominantly C5 to C22 components, or wherein the r-hydrocarbon stream comprises at least 60 weight percent of C5 to C22 components.

13. The process of claim 1, further comprising, compressing at least a portion of the cooled cracked gas stream to provide a compressed stream and separating at least a portion of the compressed stream to provide one or more recycled content hydrocarbon products (r-hydrocarbon products), and, optionally,
wherein the r-hydrocarbon products are selected from the group consisting of recycled content ethane (r-ethane), recycled content ethylene (r-ethylene), recycled content propane (r-propane), recycled content propylene (r-propylene), recycled content butylene (r-butylene), recycled content butane (r-butane), recycled content pentane and heavier (r-C5+).

14. A process for minimizing water consumption in a process for making a hydrocarbon product, the process comprising:
(a) generating steam in a steam generator;
(b) withdrawing a blowdown stream from the steam generator;
(c) cooling at least a portion of the blowdown stream; and
(d) contacting a hydrocarbon-containing gas stream with at least a portion of the blowdown stream in a caustic tower to provide a treated gas stream, and, optionally, further comprising, prior to the contacting, diluting a concentrated caustic stream with at least a portion of the blowdown stream to provide a diluted caustic stream, wherein the contacting of step (d) includes contacting the gas stream with at least a portion of the diluted caustic stream, and, optionally,
wherein the concentrated caustic comprises at least 10 and/or not more than 60 weight percent sodium hydroxide or potassium hydroxide and the diluted caustic stream comprises less than 25 weight percent sodium hydroxide or potassium hydroxide.

15. The process of claim 14, wherein the contacting of step (d) includes contacting at least a portion of the gas stream with a wash water stream to provide a washed gas stream, wherein the wash water stream comprises at least a portion of the blowdown stream, and, optionally,
further comprising contacting at least a portion of the washed gas stream with a caustic stream in the caustic tower and wherein the caustic stream comprises at least a portion of the blowdown stream, and
wherein, prior to the contacting of step (d), the hydrocarbon-containing gas stream comprises at least 1 mole percent of one or more acid gas components, and/or
wherein the treated gas stream comprises not more than 1 mole percent of one or more acid gas components,
wherein the acid gas components are selected from the group consisting of carbon dioxide (CO2), carbon monoxide (CO), nitrous oxides (NOx), sulfur oxides (SOx), and combinations thereof.

16. The process of claim 14, wherein the gas stream is a cracked gas stream withdrawn from a cracker furnace, or wherein the gas stream comprises at least 50 weight percent of C3 and lighter components, or
wherein the gas stream comprises at least 50 weight percent of olefins, and, optionally, wherein the olefins comprise at least 75 weight percent of C2 or C3 olefins, based on the total weight of olefins.

17.-18. (canceled)

19. The process of claim 14, further comprising, cracking a hydrocarbon feed stream in a cracker furnace of a cracker facility to provide a cracked gas stream, wherein the hydrocarbon-containing gas stream contacted in step (d) comprises at least a portion of the cracked gas stream, and, optionally,
further comprising, prior to the contacting, quenching at least a portion of the cracked gas stream in a quench zone to provide a cooled cracked gas stream, wherein the quenching is carried out by contacting the cracked gas stream with an aqueous quench stream, and wherein the blowdown stream comprises at least a portion of the aqueous quench stream, and, optionally,
further comprising introducing dilution steam into the hydrocarbon feed stream prior to and/or within the cracker furnace, wherein the blowdown stream comprises at least a portion of the dilution steam withdrawn from the cracker furnace.

20. The process of claim 19, further comprising pyrolyzing waste plastic to form recycled content pyrolysis oil (r-pyoil) and/or recycled content pyrolysis gas (r-pygas), and wherein the hydrocarbon feed stream comprises at least a portion of the r-pyoil and/or r-pygas, and, optionally,
further comprising combining at least a portion of the r-pygas with the treated gas and separating at least a portion of the combined gas stream to provide at least one recycled content hydrocarbon product (r-hydrocarbon product), or
further comprising introducing at least a portion of the r-pyoil into the cracker furnace with the hydrocarbon stream.

21. A process for producing a recycled content hydrocarbon product (r-hydrocarbon product), the process comprising:
(a) cracking a hydrocarbon-containing feed stream in a cracker furnace to form a cracked gas stream;
(b) quenching at least a portion of the cracked gas stream in a quench zone to form a cooled cracked gas stream;
(c) removing acid gas components from at least a portion of the cooled cracked gas stream in an acid gas treatment zone to provide a treated gas stream, wherein at least a portion of the acid gas removal is performed in a caustic tower;
(d) compressing at least a portion of the treated gas stream in a compression zone to form a compressed gas stream;
(e) separating at least a portion of the compressed gas stream in a separation zone to form at least one r-hydrocarbon product;
(f) generating steam in a steam generator;
(g) withdrawing a blowdown stream from the steam generator; and
(h) introducing at least a portion of the blowdown stream into the caustic tower.

22. The process of claim 21, wherein the introducing of step (h) includes introducing at least a portion of the blowdown stream into the upper portion of the caustic tower as or as part of a wash water stream for contacting a cracked gas ascending the caustic tower and/or includes adding at least a portion of the blowdown water to a concentrated caustic stream to provide a diluted caustic stream and introducing the diluted caustic stream into the caustic tower, and
further comprising, prior to said removing of step (c), compressing at least a portion of the cooled cracked gas stream to provide a compressed cracked gas stream and wherein the removing of step (c) includes removing acid gas components from the compressed cracked gas stream.

23. (canceled)
